(19) United States
(12) Patent Application Publication
(10) Pub. No.: US 2026/0124991 A1
(43) Pub. Date: May 7, 2026

(54) CAMERA MONITORING SYSTEM FOR MOTOR VEHICLES

(71) Applicant: Ficosa Adas, S.L.U., Barcelona (ES)

(72) Inventors: Lluís Gibert Castroverde, Viladecavalls (ES); Natalia Canosa Perez, Viladecavalls (ES); Noelia Rodriguez Ibañez, Viladecavalls (ES); Brenda Meza García, Viladecavalls (ES); Jordi Tenas Martínez, Viladecavalls (ES); Xavier Biosca Yuste, Viladecavalls (ES); Daniel Guerra Fagundez, Viladecavalls (ES); Juan Antonio Nuñez, Viladecavalls (ES)

(21) Appl. No.: 19/436,035

(22) Filed: Dec. 30, 2025

Related U.S. Application Data
(63) Continuation-in-part of application No. 16/910,980, filed on Jun. 24, 2020, now Pat. No. 12,515,588.

(30) Foreign Application Priority Data
Jun. 24, 2019 (EP) 19382531.2

(51) Int. Cl. B60R 1/28; B60R 1/06; B60R 1/12; G06F 3/01; G06T 3/20; G06T 3/40; G06V 10/764; G06V 20/52; G06V 20/59; G06V 40/20; H04N 7/18

(52) U.S. Cl. CPC B60R 1/28; B60R 1/06; B60R 1/12; G06F 3/012; G06F 3/017; G06T 3/20; G06T 3/40; G06V 10/764; G06V 20/52; G06V 20/597; G06V 40/20; H04N 7/181; B60R 2001/1253; B60R 2300/105; B60R 2300/602; B60R 2300/70

(57) ABSTRACT

A camera monitoring system is adapted for use in vehicles, and includes an image capturing means, a control unit, and at least one display device. The image capturing means is configured to capture an image from an external environment, and is associated with an exterior rear-view mirror of the vehicle. The unit is connected to the capturing means, and is configured to select an image region from the captured image. The image region is smaller than the captured image and is movable within the captured image. The camera monitoring system may further include a gesture detector for the detection of driver gestures, such as driver's head movements, to move the displayed image region. In this way, the displayed exterior field of view of the vehicle is adjusted according to the driver's head movements.

### CROSS-REFERENCE TO RELATED APPLICATIONS

This application is a continuation-in-part of U.S. patent application Ser. No. 16/910,980, filed on Jun. 24, 2020, the entire disclosure of which is hereby incorporated by reference. The U.S. patent application Ser. No. 16/910,980 claims the benefit of European Application Serial No. 19382531.2 filed Jun. 24, 2019.

### BACKGROUND

The present invention has its application within the control systems for motor vehicles comprising electronic (interior and/or exterior) rear-view mirror system.

The present invention relates to a camera monitoring system (CMS) to manage the field of view to be displayed in one or more electronic rear-view mirrors of a vehicle, including a driver gesture-detection functionality for controlling the adjustment of the displayed field of view.

Touch screens are largely known in the art. They have a spatially resolving sensor associated with a display surface, the sensor detecting a touch of the display surface, in particular at least one contact in precise positions by a finger, and so the interaction of the user with the displayed touch screen contents is possible.

US20130128047A1 discloses a touch type display mirror comprising a touch panel through which a user inputs a first signal, a photosensitive panel arranged on a rear surface side of the touch panel, and a display arranged on a rear surface side of the photosensitive panel and including a signal processing unit processing the first signal that is input from the touch panel, wherein the signal electronic processing unit (ECU) is connected to an angle-adjustable rear view camera and adjusts a shooting angle of the angle-adjustable rear view camera according to a second signal that is input from the touch panel. Thus, a mechanical actuator includes to change the position (shooting angle) of the exterior rear-view camera, where the mechanical actuator is in charge of the activation/deactivation of the camera based on the signal from the ECU which, in turn, connects to a touch panel, from where the driver enters the desired position of the rear-view by touching the screen.

A problem of the prior art is that a mechanical actuator is needed, which means cost, complexity and likelihood of damage over time.

In addition, in modern camera monitoring systems (CMS) used as electronic or digital rear-view mirror systems, the displayed field of view is typically static and not dynamically adjusted during driving. As a result, the visibility of objects located in blind-spot regions or in areas outside the fixed display window is limited. This reduced situational awareness may compromise driving safety, particularly during manoeuvres such as lane changes or merging.

Therefore, it is highly desirable to provide a motor vehicle with a control system for the electronic rear-view mirror system(s) to change the field of view of the rear-view mirror(s) without any mechanical actuator.

### BRIEF DESCRIPTION

The present invention solves the aforementioned problems and overcomes previously explained state-of-art work limitations by providing a camera monitoring system for motor vehicles, configured to display images captured from (an exterior and/or side) rear-view mirror of the motor vehicle on a screen located at an interior surface of the door visible for the driver. The proposed camera monitoring system (CMS) is capable of managing the field of view (FOV) of the means for capturing images (e.g., a camera of the electronic rear-view mirror) and changing at least this field of view without any mechanical actuator.

Optionally, the proposed CMS is capable of managing the FOV of the rear-view mirror, e.g., by touching a control surface without dirtying the screen of the display provided by the rear-view mirror. The control surface may be any surface that allows the user to manage the field of view of the image capturing means (e.g., the camera) by touching the surface (e.g., another display, another section of the display, etc.), the CMS using any touch detection technology.

Furthermore, the proposed CMS can manage the FOV of the rear-view mirror even without touching the control surface (i.e., through a touchless screen), for example, by gestures, using any gesture detection technology. The touchless control surface may be implemented in different ways such as: i) by increasing the capacity sensibility of the screen (no camera is used), ii) by using a camera based on image-classifiers.

For option ii), the proposed CMS comprises a gesture detector and a driver surveillance system (both explained further below). The gesture detector may be or comprise a driver monitoring system (DMS). The driver surveillance system may comprise an in-cabin sensor, such as an in-cabin (driver monitoring) camera, configured to capture driver gestures. In the present disclosure, said in-cabin camera is also referred to the additional camera. The driver's gestures may be movements of driver's head (e.g., moving his/her head forward in the vehicle's driving direction and/or toward a vehicle's longitudinal centerline), for example during driving. Further, the proposed CMS (e.g., the gesture detector) comprises the image classifier for detecting captured driver gestures (e.g., determining the driver's head location and/or movements). In examples, the image classifier comprises a machine learning model, such as deep learning. That is, the driver surveillance system (e.g., the in-cabin camera) acquires image data of at least the driver, and the image classifier detects or determines the location and/or movements of the driver's head. For this, the image classifier includes a trained machine learning model. In particular, the driver gesture detection functionality allows the CMS to continuously and dynamically adjust the displayed exterior field of view (FOV) of the rear-view mirror, so that blind-spot visibility is improved in a dynamic manner during driving.

The change of the FOV displayed may be performed by the CMS only in predetermined conditions. For example, the field of view can only be changed when the motor vehicle is stopped (i.e., not moving). In order to find out whether the vehicle is moving or not, the CMS can use the electronic control unit (ECU) of the vehicle, which is connected to the communication bus (e.g., CAN) of the vehicle. Alternatively, determining if the motor vehicle not moving can also be done by using at least one camera which takes a plurality of frames (images) and a control unit which compares the frames (current frame vs. previous frame) to determine if the difference between frames is enough to decide that there is a movement.

An aspect of the present invention refers to a camera monitoring system for motor vehicles which comprises:
Image capturing means (e.g., a camera) being associated with at least an exterior rear-view mirror of a vehicle. In the context of the invention, the exterior rear-view mirror refers to a mounting assembly (e.g., a winglet or a sharkfin) located at an exterior part of the vehicle and where the image capturing means are located/mounted. The image capturing means are configured to capture an image (e.g., to acquire a raw image) from an exterior field of view of the vehicle, the field of view (FOV) extending at least sideward and rearward outside the vehicle and encompassing a portion of the exterior part of the vehicle (preferably an exterior lateral part or side of the vehicle). That is, the image capturing means is configured to acquire the raw image. A captured image is derived from the raw image. For this, the captured image includes a symmetric image of the raw image with respect to a vertical axis of the captured image (e.g., raw image), which is the mirroring.
An electronic control unit or ECU, which is connected to the image capturing means. The ECU is configured to select at least an image region (or image section) from the image captured by the image capturing means. The image region selected by the ECU is smaller than the image captured by the image capturing means. And the selected image region can be moved within the captured image. The above-mentioned symmetric image may be generated by one of an image sensor of the image capturing means, an image signal processor (ISP), and the ECU.
At least one display device located inside the vehicle and connected to the ECU. The display device comprises at least one screen. The, at least one, screen of the display device can be a touch screen and, in this case, the camera monitoring system may further comprise a control surface in the touch screen configured to move the image region displayed by the, at least one, display device (in said screen or in another screen of the display device). Additionally, or as an alternative option, the camera monitoring system further comprises a gesture detector to move the displayed image region. That is, the gesture detector is implemented in the ECU. In other words, the ECU may be or comprise the gesture detector.

Another aspect of the present invention refers to a motor vehicle comprising two camera monitoring systems (CMS) as described above, wherein one CMS is located on the left side of the vehicle (with image capturing means associated with the exterior rear-view mirror(s) of the left side), and the other CMS is located on the right side of the vehicle (with image capturing means associated with the exterior rear-view mirror(s) of the right side). The ECU being the one controlling the two camera monitoring systems. It may further comprise an interior rear-view mirror system. If so, the ECU may also control the interior rear-view mirror system.

The present invention has a number of advantages with respect to prior art, which can be summarized as follows:
The present invention allows a vehicle vision system capable of adapting the displayed images in function of user setting and/or current driving information.
The present invention allows the FOV adjustment of the exterior cameras, which are fixed on the body of the vehicle, without the need of actuators or mechanical movements on these cameras. In this way, the blind-spot visibility is improved in a dynamic manner during driving.
The present invention allows the size reduction of the side mirror, because the mirror element of the side “mirror” can be avoided, and it is well-known that a camera may be smaller than the entire mirror surface that reflects light. Moreover, screens in the exterior are avoided, since the location of the screen (display) is changed from the exterior to the interior (e.g., the screen is located inside the car, preferably on the door).
The present invention allows the control be performed using a multi-touch-sensitive display adapted to detect gestures. The control actions are then triggered by the driver's gestures, instead of pushing digital buttons (overlays) on top of the displayed image, or instead of touching the display with fingers (which get the screen dirty), and a larger area of action is provided, that is, the driver can make the relevant gesture (with his/her head or fingers) in the air and not in a small/limited-size screen.

These and other advantages will be apparent in the light of the detailed description of the invention.

### BRIEF DESCRIPTION OF THE DRAWINGS

For the purpose of aiding the understanding of the characteristics of the invention, according to a preferred practical embodiment thereof and in order to complement this description, the following Figures are attached as an integral part thereof, having an illustrative and non-limiting character:

FIG. 1 shows a motor vehicle with a camera monitoring system, CMS, using two exterior rear-view mirrors or winglets and three interior displays, according to a possible embodiment of the invention;

FIG. 2 shows a schematic representation of a touch screen in one of the displays split into two portions by the ECU for the CMS, according to a possible embodiment of the invention;

FIG. 3 shows an exploded view of the display with a touch screen and a frame cover, according to another possible embodiment of the invention;

FIG. 4 shows an exploded view of the display with a touch screen and a touchless screen, and a frame covering both screens, according to a further possible embodiment of the invention;

FIG. 5 shows a frame with screen printed buttons for the camera monitoring;

FIG. 6 shows a block diagram representing the CMS components, according to a preferred embodiment of the invention;

FIG. 7 shows the left exterior winglet and the associated interior display, according to a possible embodiment of the invention;

FIG. 8 shows a schematic representations of a first image section controlled by the CMS of the image to be displayed;

FIG. 9 shows a schematic representation of a second image section controlled by the CMS of the image to be displayed;

FIG. 10 shows a schematic representation of a third image section controlled by the CMS of the image to be displayed;

FIG. 11 shows a schematic representation of a fourth image section controlled by the CMS of the image to be displayed;

FIG. 12 shows a schematic representation of a fifth image section controlled by the CMS of the image to be displayed;

FIG. 13 shows a schematic representation of a sixth image section controlled by the CMS of the image to be displayed;

FIG. 14 shows the motor vehicle with different fields of views captured by external cameras of the vehicle.

FIG. 15 shows a movement of the driver's head forward and the movement of the displayed image accordingly.

FIG. 16 shows a movement of the driver's head upwards and the movement of the displayed image accordingly.

FIG. 17 shows the raw image captured by a camera located at the driver's side.

FIG. 18 shows two pictures of the captured image provided by the camera located at the driver's side and the displayed image moving within the captured image, in the left picture the image region of the captured image which is displayed is for a first position of the driver's head and in the right picture when the driver's head moves a few millimeters forward in the driving direction.

### DETAILED DESCRIPTION

The matters defined in this detailed description are provided to assist in a comprehensive understanding of the invention. Accordingly, those of ordinary skill in the art will recognize that variation changes and modifications of the embodiments described herein can be made without departing from the scope and spirit of the invention. Also, description of well-known functions and elements are omitted for clarity and conciseness.

Of course, the embodiments of the invention can be implemented in a variety of architectural platforms, operating and server systems, devices, systems, or applications. Any particular architectural layout or implementation presented herein is provided for purposes of illustration and comprehension only and is not intended to limit aspects of the invention.

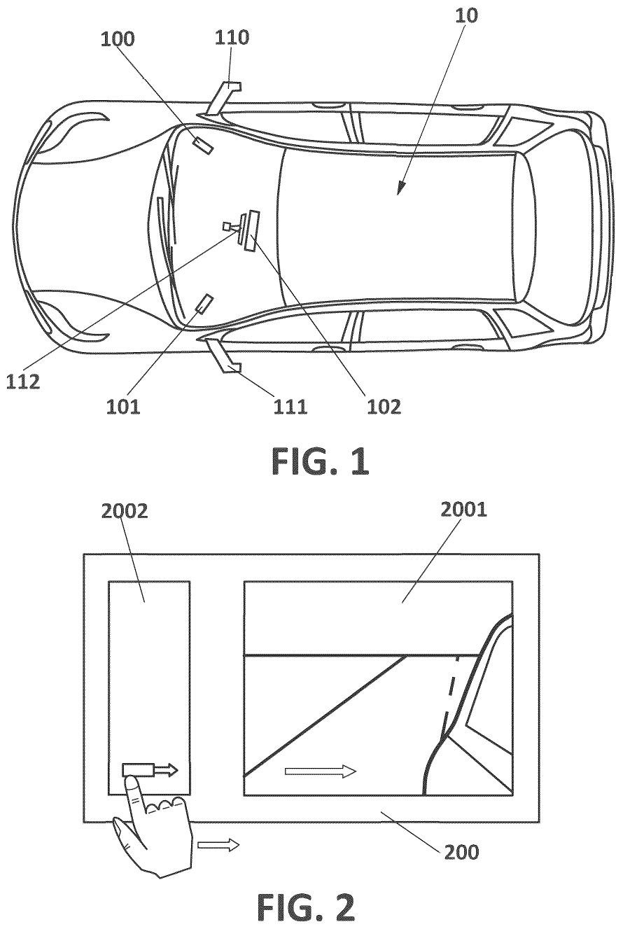

FIG. 1 presents a motor vehicle 10 with a camera monitoring system, CMS, which comprises image capturing means (e.g., a camera, such as external CMS cameras 1102, 1112) configured to captures images, the image capturing means being associated with an exterior mounting assembly (e.g., a winglet or a sharkfin), the mounting assembly being located at an exterior part of the (body side of the) motor vehicle 10. The image capturing means can be located, even fixed, outside the vehicle 10. The image capturing means are configured to capture an image from an exterior field of view of the motor vehicle 10, wherein the field of view extends at least sideward and rearward outside the vehicle 10. This field of view also encompasses a portion of the exterior side part of the vehicle 10 body at which the mounting assembly is located. Preferably, the image capturing means can capture a field of view extended at least twenty meters rearward and four meters sidewards.

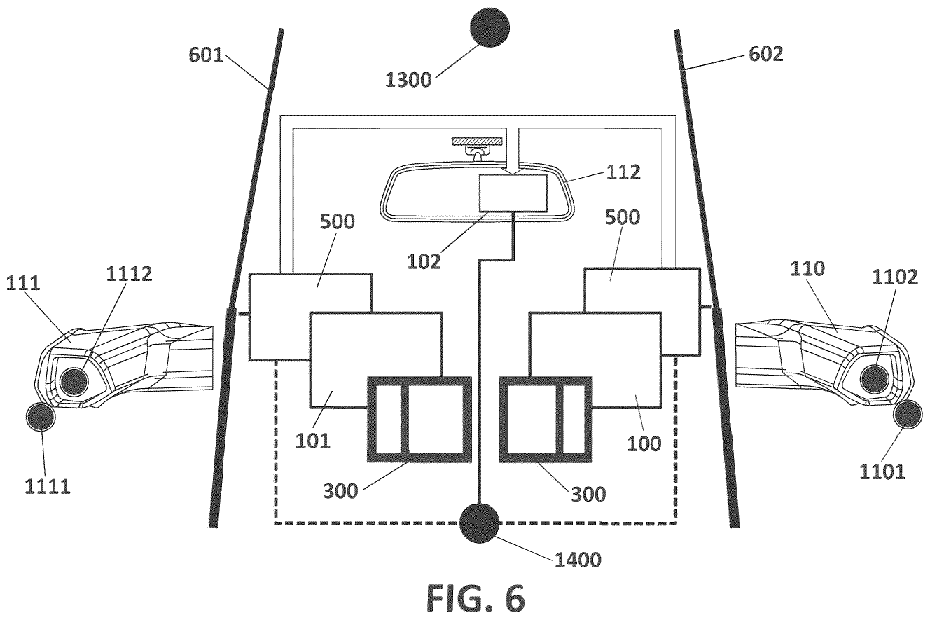

For example, FIG. 1 shows two exterior rear-view mirrors 110, 111 at each side of the motor vehicle 10 and an interior rear-view mirror 112. Any of the exterior rear-view mirrors 110, 111 can be a (mechanically) mobile winglet or can be fixed (not mobile). In the case of being fixed, one option is to use a (i) winglet, which may be extendible; or (ii) a “sharkfin”, more specifically, having two cameras (one for the top-view and one for the CMS) in the same mounting assembly housing. The CMS for the vehicle 10 shown in FIG. 1 comprises image capturing means located outside and associated with the exterior rear-view mirrors 110, 111; and the image capturing means, which is the rear camera 1400 (see FIG. 6), for the interior rear-view mirror 112. Said rear camera 1400 may be located within a sharkfin.

The CMS further comprises an electronic control unit or ECU 500 connected to the image capturing means, configured to select an image region 210, 211 from the image captured by the image capturing means (e.g., the external CMS cameras 1102, 1112). The image region 210, 211 is smaller than the captured image; i.e., is obtained by cropping the image from the image capturing means.

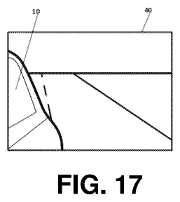

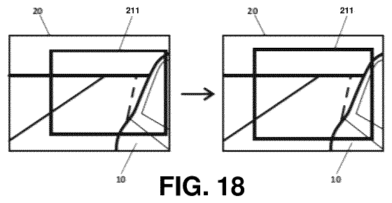

The image capturing means may be configured to acquire a raw image 40 (see FIG. 17). The captured image 20 may be derived from the raw image 40 acquired by the image capturing means. As shown in FIG. 18, the captured image 20 includes a symmetric image of the raw image 40 with respect to a vertical axis of the captured image (e.g., raw image). The symmetric image may be generated by at least one of (i) an image sensor of the image capturing means, (ii) an image signal processor (ISP), and (iii) the ECU 500. In particular, option (i) may allow obtaining the captured image directly from its hardware architecture. Options (ii) and (iii) involve image processing to obtain the captured image in which at least one image region 210, 211 can be moved in response to driver gestures or driver's head movements.

In examples, a System-on-Chip (SoC) may be provided. The SoC may include the image sensor of the image capturing means or the ISP. For example, the SoC may be arranged at the image capturing means, or integrated with the ECU. The ECU 500 or SoC is configured to generate the captured image as a symmetric image in real-time, such that the image region 210, 211 is immediately updated based on detected driver gestures or driver's head movements. The ECU 500 or SoC performs real-time image processing of the captured exterior field of view and updates the position of at least one image region 210, 211 within the captured image 20 in a manner effectively concurrent with detection of the gestures (e.g., driver's head movements). By performing symmetry generation and image-region updating within a common processing domain, temporal alignment between the captured image and the detected driver's head movement is maintained, thereby improving the stability and responsiveness of the displayed exterior field of view. In such examples, the camera monitoring system (CMS) processes and updates the image region 210, 211 with sufficiently low latency that a human driver perceives the change as immediate rather than delayed, consistent with latency thresholds at which visual feedback becomes perceptible. As used herein, “real-time” refers to processing and updating the image region with sufficiently low latency that updates are perceived as immediate from the driver. For example, the total latency from acquisition of the raw image 40 to display the displayed image through a display device 100, 101, 102 may be less than 200 milliseconds.

The CMS further comprises at least one (first) display device 100, 101, 102 located inside the motor vehicle 10, for example as shown in FIG. 1, and connected to the electronic control unit, ECU, 500. The ECU 500 inputs the image region into the display device 100, 101, 102 to be displayed as a cropped image instead of displaying the entire captured image. That is, the ECU 500 does not input the whole captured image into the display device 100, 101, 102. Moreover, said image region 210, 211 can be moved within the captured image in response to a user's action, which can be: i) a touch by the user on a control surface of the display device 100, 101, 102 and/or ii) a gesture made by the user to a gesture detector that can be implemented in said display device 100, 101, 102, or by another device using any gesture detection technology. This enables a variety of interactive options for the driver.

The control surface can be implemented in a touch screen 200 of the (first) display device 100, 101, 102 preferably working as a multi-touch-sensitive display configured to receive a user's touch so as to move the image region within the captured image.

In examples, the touch screen 200 is configured to detect different places touched simultaneously, in particular by a finger. The multi-touch-sensitive display allows tracking of images and touch carried out not only by one finger, but also complex actions, requiring operation with two or more fingers, can be performed. With particular advantage, the multi-touch-sensitive display may be further provided with a magnification of image regions by using two fingers and a change in the spacing of the fingers during contact is adjustable. In particular, together with the panning, a simple adjustment of the desired composition including the zoom level (zoom in/out) can be given by simple movements of the fingers. Therefore, the CMS comprises an associated touch screen controller configured to detect also movements and/or touches of one or more fingers by increasing the sensitive capacity of the touch screen 200.

In the case of exterior rear-view mirrors 110, 111 and/or wing mirrors, as shown in FIG. 1, the touch screen 200, in an interior part of the motor vehicle 10, can be provided for only one of the exterior (or wing) rear-view mirrors 110, 111. Through this touch screen 200, at least one parameter of the one exterior rear-view mirror 110, 111, in particular an operation parameter related to pivoting of the external camera and/or presentation parameters of an image section/region of the image captured by the external camera, can be adjusted.

In another embodiment, the touch screen 200 can be additionally arranged for an interior rear-view mirror 112 in an interior part of the motor vehicle 10. Typically, the interior rear-view mirror 112 and the exterior rear-view mirrors 110, 111 are connected through the ECU 500.

The multi-touch-sensitive screen 200 of the display device 100, 101, 102 can be configured to be an “only-touch” screen. That is, instead of having a “touch and drag” screen, the CMS provides the touch screen 200 with two different portions as the ECU 500 distinguishes: a first portion of the touch screen 200 in which the user/driver is not enabled to perform “touch and drag” of the displayed image, and a second portion in which the user/driver can perform normally the “touch and drag” operation provided by the multi-touch-sensitive screen 200.

According to this example, the user can perform only “touch” in the first portion or “touch & drag” in the second portion. The technical advantage of doing so is that the first portion does not get dirty. In this example, the light (image) received by the second portion comes from the same image of the display as the first portion. Preferably, the first portion is larger than the second portion. Preferably, the area of the second portion is approximately 30% of that of the first portion. Preferably, the length of the second portion is 20% of the length of the first portion, the length being defined along an X (horizontal) axis.

Therefore, instead of having a screen on each side (on the inside of the door) of the vehicle 10 and the screen being totally “touch and drag” for its whole surface, according to a possible embodiment, a single touch screen 200 on each side of the vehicle 10 is connected to the ECU 500, which distinguishes between a first portion 2001 and a second portion 2002 of the touch screen 200, as shown in FIG. 2. The ECU 500 deactivates the first portion 2001 of the touch screen (200) so that the user cannot do the “touch and drag” in said first portion 2001 working as an “only-touch” screen, while the “touch and drag” is activated by the ECU 500 only in the second portion 2002. According to another embodiment, the ECU can even deactivate the entire “touch” function in the first portion 2001 of the touch screen 200. The user is enabled to use the second portion 2002 to adjust the FOV and the brightness and/or contrast and/or color parameters of the image region displayed in the first portion 2001.

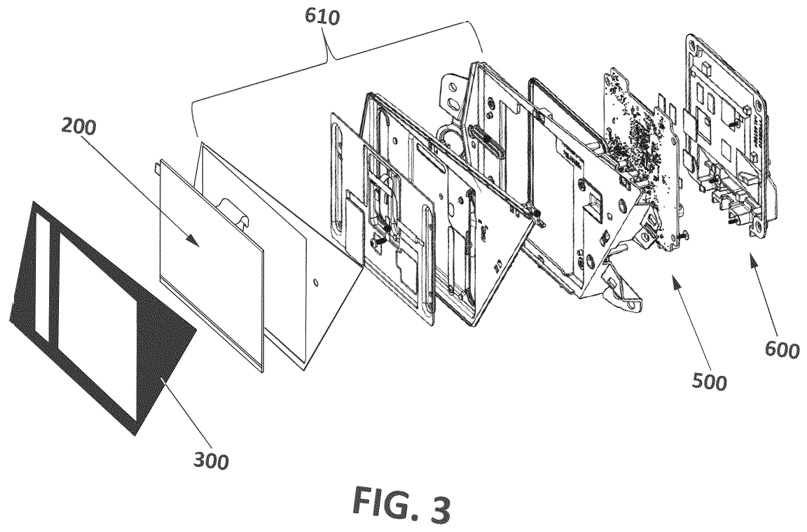

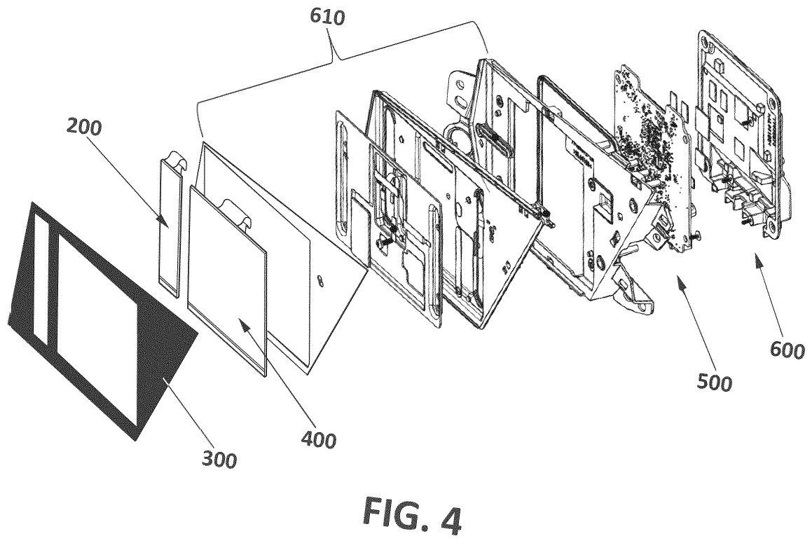

In an embodiment, in order to implement the aforementioned two portions 2001, 2002 in the first display device 100, 101, 102, the CMS further comprises a frame 300 covering partially the first display device 100, 101, 102, as shown in FIGS. 3-4. For example, on the inner side of a door of the vehicle 10, there can be a housing 600, which is adapted to be coupled with fixing means 610, to fix a controller or ECU 500, a touch screen 200 and the frame 300, to the door or anywhere inside the vehicle 10. Thus, the order of location of these different elements is as follows: first, housing 600; second, the ECU 500; third, the fixing means 610 belonging to the enclosure; fourth, the screen 200, or screens 200, 400, of the display device 100, 101, 102; and finally, the frame 300 covering the whole display device and showing the part(s) of the screen(s) which can be seen by the user.

This frame has the same dimensions as the touch screen 200 or significantly larger to cover at least the entire touch screen 200. The frame 300 is a cover, preferably made of plastic or glass, which also protects the display device 100, 101, 102 from impacts and damages, since the touch screen 200 is relatively fragile. The frame 300 is partially tinted. Preferably, the tinting is black. Said frame does not allow all the light emitted by the touch screen 200 can pass. Therefore, the driver does not see the light emitted by the display where the frame is tinted, i.e., silkscreen. The frame is placed, for example, on top of the touch screen 200, and so what the user sees is the “frame” 300, since it is placed between the screen and the user.

As described before, the frame 300 can be partially tinted; more particularly, comprising a (first) section that is not tinted, while the rest of the frame is stained. The transparent or non-tinted portion of the frame, from which the light of the display comes out and becomes visible by the user, can present different forms. Therefore, only the section of the frame (image) that is not tinted is shown/perceived to/by the user, but not all the image emitted by the display. According to a non-limiting example, as shown in FIG. 3, (the first) non-tinted section of the frame has a size of approximately 60% of the total screen 200 and, preferably, its geometry 200 is rectangular. The geometry of the non-tinted section is purely aesthetic.

The ECU 500 deactivates the first portion of the touch screen 200 according to the specific geometry of the (first) non-tinted section of the frame.

According to another possible embodiment, the first display device 100, 101, 102 has an additional, second screen 400 in addition to the multi-touch-sensitive screen 200. Having two screens, as shown in FIG. 4, the first portion 2001 distinguished by the ECU 500 can be implemented in the second screen 400, which can be touchless and then cheaper, and the second portion 2002 in the touch screen 200 without requiring to deactivate the “touch and drag”. And also, this second portion 2002 implemented in the touch screen 200, preferably smaller than the touchless screen, can display the parameters related to brightness and/or contrast and/or color of the additional screen to be adjusted by user's touch. One technical advantage is the cost of non-touch-sensitive screens. The additional screen 400 only displays the image region selected by the ECU 500 from the images captured by the image capturing means. In this case, the controller or ECU 500 can manage the image movement (i.e., “pan”) of the image region displayed in the first portion 2001 based on the data or instructions captured in the second portion 2002 by the touch screen 200.

In a further possible embodiment, the CMS can take advantage of the second portion 2002 (implemented in a single touch screen 200 or in an additional screen as described before) to indicate a Blind Spot Detection or BSD, i.e., if an object is detected in the blind spot, the CMS turns on an indicator (triangle, exclamation, etc.) in said second portion 2002 of the first display device (100, 101, 102).

The CMS can be additionally provided with at least one (second) display device (another touch screen) to display parameters of the first display device 100, 101, 102, i.e., operation parameters of the touch screen 200. The first display device 100, 101, 102 itself can also display the parameters to be adjusted. More particularly, the touch screen 200 allows the user by his/her touch to set brightness and/or contrast and/or color parameters of the first display device 100, 101, 102. Therefore, parameters are adjustable directly on the touch screen of the display device with respect to the optical impression of the image display parameters shown on the display. The driver can make the image lighter or darker, to choose contrast and other common parameters, in particular color-related parameter set of the images displayed in the touch screen 200. In a possible embodiment, the CMS is designed for inserting or superimposing a slider bar for the presentation parameters on the display device.

Additionally, at least one operating parameter of the first display device 100, 101, 102 can be used by the CMS to output an item of information and/or a warning, in particular to be used by a driver's assistance system (e.g., a lane change assistance system and/or a blind spot assistance system and/or parking assistance and/or a reversing assistance system) provided in the vehicle 10. The output of this information and/or a warning is adjustable depending upon an input on the touch screen 200.

Additionally, at least one item of additional information can be superimposed into the image displayed on the touch screen 200 and can be moved, by interaction at the display location of the additional information in the touch screen 200. In another embodiment, context-sensitive menus of items which can be activated by the touch screen 200 and displayed on the display device 100, 101, 102.

The ECU 500 or control unit can provide some digital buttons to be overlaid on the image shown in a second portion 2002 of the touch screen 200. For example, after selecting a specific adjustment possibility which can be done through a menu and/or a depicted control, thus a slider is displayed on the control surface of the touch screen 200, which can be gripped, for example by contact at the position of the slider and manipulated to adjust the display parameters. Of course, other possibilities are conceivable to make the presentation parameter set, for example with “+” and/or “−” labeled on the display area on-screen controls that trigger corresponding to an increase or decrease of the presentation parameter if a touch is sensed (zoom function). Particularly advantageously, it is also when the touch screen 200 can also be used to set further parameters. The control unit can be configured to form a touch screen menu on the screen 200. Thus, when the menu is selected by a touch, a menu can be displayed, which allows the setting of parameters of the winglet. The driver can touch with a finger (or with a pen) the image portion on one of the labelled symbols and cause a setting menu open different options (or additional information) in the image portion. Therefore, overlaid symbols are then placed with a menu having multiple menu items related to display parameters; in particular, for contrast, brightness and color parameters. It is also conceivable that by tapping the touch screen shown outside controls/menu items return to the default display. Additionally, touching the additional information can result in a corresponding menu with settings concerning the lane change assistant, i.e., in particular operating parameters of the lane change assistant.

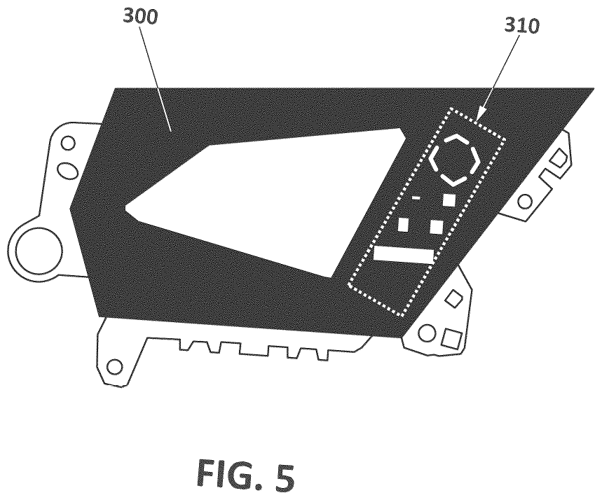

Another option is to draw (or taint) buttons 310 on the frame 300, as depicted in FIG. 5, so that the user can touch the drawn button (the button is not a mechanical component that moves) to trigger digital buttons on the screen 200.

According to an example, the frame and the screen 200 are together and in contact. According to another example, there is a gap between the frame and the screen 200 and preferably the gap is between 0.5 mm-4 mm. According to a further example, a joystick including the typical mouse ball (not optical) for computers or physical push buttons can be used. The joystick and/or the push buttons can be located anywhere the driver has access when driving; for example, on the door, on the dashboard (central console), on the steering wheel, etc. The push buttons can have a cross-shaped distribution, in order to move up/down/left/right. The joystick can have a cross or circular movement which allows the image to be moved according to the movement of the joystick. Switches or auxiliary pushbuttons can allow the user to choose between the different options (e.g., left or right CMS). A trackball can also be used, which allows greater precision in adjusting the position of the image since the trackball detects small movements of the ball. Also, a touchpad can be used, as the press of a button can be simulated by pressing the touchpad, so that the user can move the finger across the length and width of the pad to determine the movement of the image. Other types of elements sensitive to human touch such as plastic material or smart textiles can be used. All these above-mentioned elements can be placed in different elements of the car, (without being limiting): door, driver's side panel, center console, central tower (central armrest), steering wheel, etc.

FIG. 6 shows the image capturing means used by the CMS, which can be an external camera 1102, 1112 rearwardly oriented and located at opposite sides (outside) of the vehicle 10, for capturing the external environment. Each CMS camera 1102, 1112 is fixed on an exterior rear-view mirror 110, 111 which is a winglet, and preferably the winglet is fixed to the outside of the car door 601, 602. In addition, the winglets at both side of the vehicle 10 incorporate respective top-view cameras 1101, 1111, but none of them are used by the CMS. Moreover, the vehicle 10 has a front camera 1300 and rear camera 1400, used by the ECU 500 to do the top-view by stitching. In a particular example, only one display device 101 associated with one of the corresponding winglets, in Europe and the Unites States only the left exterior rear-view mirror 111, is actually reached by the driver. Thus, it is particularly advantageous if a touch screen 200, e.g., of the left display device 101 can control the image region, e.g., the field of view adjustment, displayed in another screen/portion of the left display device 101.

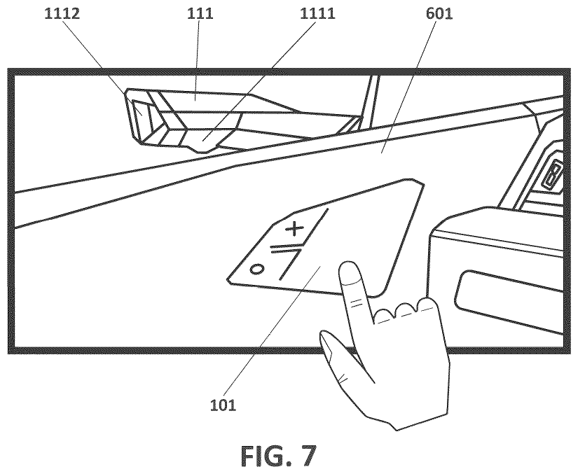

More particularly, FIG. 7 shows the left exterior rear-view mirror 111 which is a winglet fixed on the outer side of the left door 601 and incorporates two fixed cameras: a first camera down for the top-view 1111 and a second camera focused back for the CMS 1112. The left display device 101 is fixed on the other, the inner, side of the left door 601 so that the user, the driver usually, can adjust the FOV of the CMS camera by touches. The top-view camera 1111 is usually positioned with a relative angle (e.g., around 2°-20°) from the perpendicular to the ground and said angle varies according to the model of the vehicle (length of the car, height of the car, shape of the external surface where the mounted assembly housing is placed on, e.g., shape of the door, etc.).

In a possible embodiment, each—right, left—winglet of the CMS can comprise:
a) a camera focused sensibly backwards, which is the so-called-right, left-CMS camera 1102, 1112;
b) a camera focused sensibly down, which is the—right, left—top-view camera 1101, 1111;
c) a camera focused sensibly forward, which is useful, for example, when the driver overtakes. Especially when he/she overtakes the vehicle in front on the right, there is no visibility of what is ahead (e.g., in the area adjacent in front of the vehicle); then, thanks to this front camera, the image of what is ahead can be displayed in the second portion 2002, preferably displayed by a second screen 400.

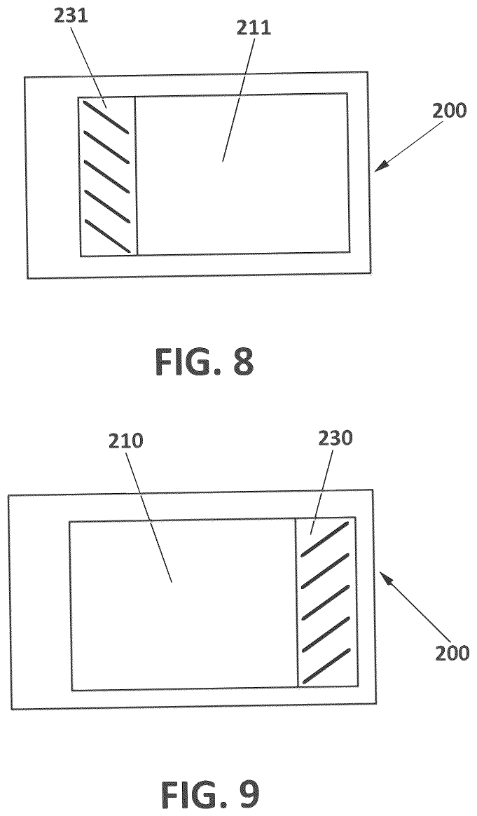

FIG. 8 shows the touch screen 200 of the left display device 101 normally used by the driver, while FIG. 9 shows the touch screen 200 of the right display device 100, for example fixed at the co-driver's side. The second portion of the display devices 100, 101, implemented in the touch screen 200, displays an image region 210, 211 of the image captured by the respective external CMS cameras 1102, 1112. A zoom level of the image region 210, 211 is adjustable by positioning two fingers on the touch screen 200 and changing the distance between the fingers whilst touching.

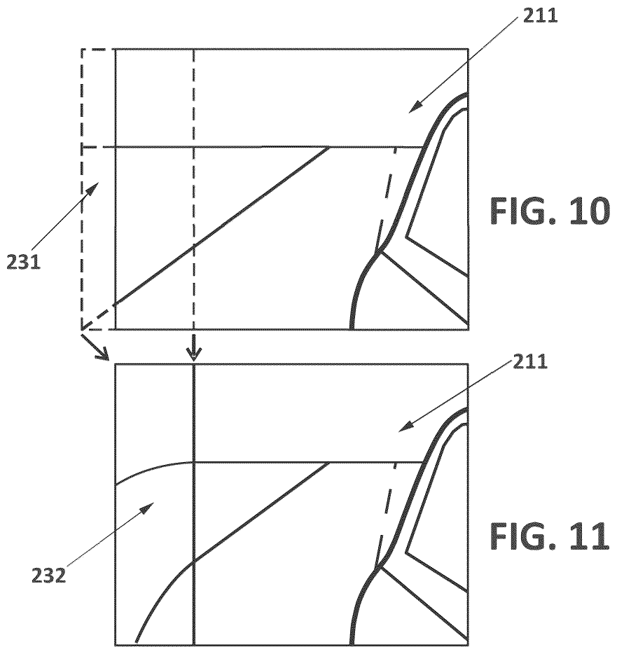

Optionally the image region 211 displayed in the second portion of the left display device 101 may further comprise an additional image section 232, as shown in FIG. 11, obtained by the ECU 500, which selects the extreme side of the image 231, shown in FIG. 10, captured by the left external CMS camera 1112 and reduces its width. Thus, the additional image section 232 shown in FIG. 11 corresponds to the narrowed image of the extreme side of the captured image 231 shown in FIG. 10, increasing significantly the FOV of the left external CMS camera 1112 simulating an aspherical view mirror in the left exterior rear-view mirror 110. The same effect of outer aspherical view mirror can be achieved in the right exterior rear-view mirror 100 for the co-driver, displaying a second additional image section 230 corresponding to a narrower image of the extreme side from the image captured by the right external CMS camera 1102.

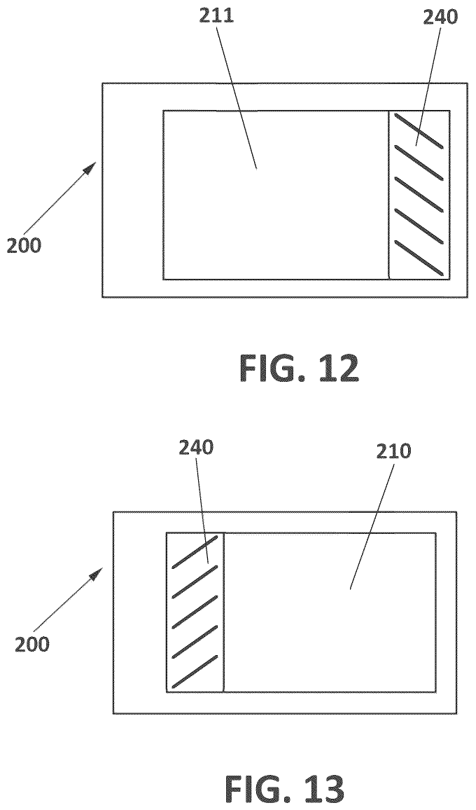

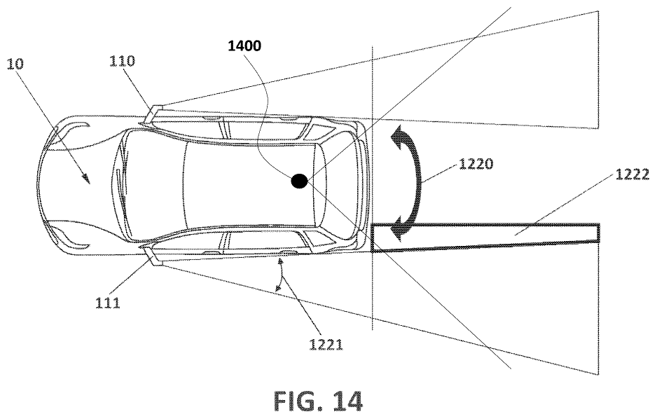

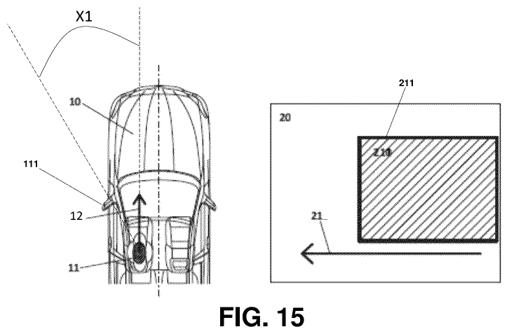

Optionally, as shown for the left display device 101 and the right display device 100 in FIG. 12 and FIG. 13 respectively, the touch screen 200 presents a third additional image section 240, which shows the image captured by the rear camera 1400, displayed at the side opposite to the image region 210, 211 of the image captured by the respective external CMS cameras 1102, 1112. This third additional image section 240, 241 allows the driver to see behind the vehicle through the display devices 100, 101 associated with the exterior rear-view mirrors 110, 111, which minimizes the number of displays required. According to a further example, the third additional image section 240 is shown on the second portion 2002 of the display device. Also, the driver can see the adjacent area 1222 of the “side zone view”, i.e., the zone between the “rear zone” 1220 and the “side zone” 1221, as shown in FIG. 14, in a “single” image on the driver's display, typically the one associated with the left exterior rear-view mirror 111.

According to a variation of the previous embodiment, in the case that the rear camera 1400 is left without an image to be displayed in the second portion of the display devices 100, 101, the image from the corresponding top view camera 1101, 1111 of the display devices 100, 101 can be taken. This is useful when the image region 210, 211, as being moved inside the captured image, can reach an edge (extreme) of the captured image. In this case, since the image region 210, 211 is shown on the first portion 2001, there is no image to be shown on the second portion 2002; however, when this happens, the ECU 500 detects it and selects the “top view” image to be shown on the second portion 2002. The ECU 500 can select: (i) the top view of the top-view camera of a single CMS device; or (ii) the top-view of the surrounding view, that is, after doing the “stitching” of the four top-view images from left, right, front and rear cameras. Optionally, instead of showing the top-view, the image from the area 1222 captured by the rear camera 1400, i.e., it is not all the rear image, but the portion of the adjacent/complementary rear image, can be displayed on the second portion 2002 or second screen 400.

In a possible embodiment, the display devices 100, 101, 102 can be controlled by the user, driver or co-driver, from a smartphone or tablet, e.g., via Bluetooth. The CMS can automatically load the settings previously input by the driver (i.e., user preferences of the device owner: default position, views . . . ) into his/her smartphone or tablet to the ECU 500.

In a further embodiment, the controller or ECU 500 of the CMS is configured also to receive and process vehicle driving and/or user information, and the image region 210, 211 is moved within the captured image depending on said received information. The vehicle driving information at least corresponds to a change in driving direction from a forward driving direction to a reverse driving direction or vice versa, an increase or decrease in driving speed with respect to a predefined driving speed value, a lane change, a change in steering angle, a change in pitch angle, a change in roll angle, and road monitoring information.

In an example, the ECU 500 is further configured to:
move the image region 210, 211 corresponding to a downward vertical displacement such that the field of view, FOV, is vertically displaced in a downward direction, when the driving direction is changed from a forward driving direction to a reverse driving direction, and
move the image region 210, 211 corresponding to an upward vertical displacement such that the field of view, FOV, is vertically displaced in an upward direction, when the driving direction is changed from a reverse driving direction to a forward driving direction.

In a further example, the ECU 500 is configured to determine a relative upward and downward movement of the exterior rear-view mirror 110, 111 from a change in the pitch angle value, and further configured to:
move the image region 210, 211 corresponding to a downward vertical displacement such that the field of view, FOV, is vertically displaced in a downward direction, when the exterior rear-view mirror 110, 111 is downwardly moved, and
move the image region 210, 211 corresponding to an upward vertical displacement such that the field of view, FOV, is vertically displaced in an upward direction, when the exterior rear-view mirror 110, 111 is upwardly moved.

In a further example, the ECU 500 is configured to receive a lateral displacement of the vehicle, for example, by a change in the steering angle value, and further configured to:
move the image region 210, 211 corresponding to a rightward lateral displacement such that the field of view is laterally displaced in a leftward direction in the event of a left lane change, and
move the image region 210, 211 corresponding to a leftward lateral displacement such that the field of view is laterally displaced in a rightward direction in the event of a right lane change.

In a further example, the ECU 500 is configured to move the image region 210, 211 such that the zoom of the displayed image increases when the driving speed is increased and such that it surpasses the predefined driving speed value, while the image region area is decreased when the vehicle speed falls below a predefined driving speed value. Thus, a smaller part of the captured image is selected as image region 210, 211, and then an enlarged image is displayed when over speed is detected by the ECU 500. In this way, the driver has a better view of the area of interest, which in this case, corresponds to a more detailed view of the farthest area from the vehicle.

Preferably, the ECU 500 is configured to receive an activation signal such a blinker, and further configured to move the image region 210, 211 upon receiving said activation signal.

In a further embodiment, the CMS can work with speed or other measurements (e.g., if the reverse gear is engaged in parking situations) obtained from the CAN, or another network (e.g., Ethernet, etc.) which the ECU 500 is communicated with. The same measured speed signal can be used to adjust the FOV of the entire system in the vehicle 10, shown in FIGS. 1 and 6, comprising: a “right CMS” corresponding to the camera/s or image processing means 1102 associated with the right left exterior rear-view mirror 110, 111, a “left CMS” corresponding to the camera/s or image processing means 1112 associated with the left exterior rear-view mirror 111 and the interior rear-view mirror 112. The interior rear-view mirror system 112 and/or the CMSs 110, 111 are controlled by the same ECU 500. The ECU 500 can be configured to compare current images with previous images to act as a “back up” in case the CAN does not work (because there are wireless cameras that cannot be physically connected to the CAN, or because the CAN is damaged or because there are values that are not transmitted correctly through the CAN). Furthermore, the CMS can store images in case of accident detection. The ECU 500 can be connected to the CAN of the car and the CAN itself that determines when there is an accident or not. Alternatively, the ECU 500 also comprises accident detection means. Generally said accident detection means comprise an accelerometer. This accelerometer is configured so that it never jumps in maximum acceleration of the car or a braking, but when there is a shock where the deceleration is greater. In any case, the images are not hidden with overlays of digital buttons.

The driver can adjust the FOV of the interior rear-view mirror through the “touch & drag”, preferably provided by the second portion 2002 of the CMS display device 100, 101, 102. While traditional central rear-view mirrors are tilted because the driver is on the left side of the car and wants to see what is behind, the interior rear-view mirror system, which provides the driver with a display showing the image of the rear camera associated with the interior rear-view mirror, are centered. The driver can perform a “crop & pan” of the rear camera through the “touch & drag” functionality e.g., in the second portion 2002. In “crop & pan” functionality of the interior rear-view mirror system, the rear camera captures an image, in which a controller-either a single ECU 500, any of the CMS's ECUs 500, or the ECU of the interior-rear view mirror system-selects a portion of the image or “image region” that appears (i.e., is displayed) on the display device of the interior rear-view mirror system.

According to another embodiment, the CMS comprises, as alternative to the before described approach based on a control surface of the touch screen or in addition to it, a gesture detector so as, for example, to move the image region 210, 211 within the image captured by the exterior image capturing means. For example, by gestures of the driver's fingers or to allow the driver command the CMS to expand the FOV by a head movement. There are three implementation options for the gesture detector:
i) In a possible embodiment, gestures (e.g., driver's head movements) can be recognized in images of the user (e.g., driver) captured by an additional camera (e.g., being part of a surveillance system explained below) inside the vehicle 10, for example, near the user's display or in the interior mirror, and the ECU 500 (e.g., the gesture detector) is configured to use an image classifier by to avoid false positives and false negatives in the detected gestures. In other words, the surveillance system comprises the additional camera inside the vehicle configured to capture the driver's head, such that driver's head movements are recognized in images of the driver captured by the additional camera.
ii) In another possible embodiment, no extra camera is needed, the gestures are performed on the display without touching it and they are detected by simply increasing the capacity sensibility of its screen.
iii) A further possible embodiment is based on electrical near-field (E-field) 3D gesture controllers that enable user gesture detection and motion tracking by using a single-chip device with no host processing needed for embedded applications. Thus, only by turning his/her head or waving one hand, the CMS detects that the driver wants an opening (greater) of his/her FOV, and consequently increases the FOV of the external camera. Therefore, this preferred embodiment provides multiple possible locations from which the driver can make the movements.

In a preferred embodiment of the CMS using a gesture detector, the crop-and-pan functionality (i.e., moving or displacing the image region 210, 211 within the captured image) may be triggered by the driver's head movement. The driver's head movement may be tracked by the surveillance system, which is preferably within the vehicle 10, more preferably fixed (i) in front of the driver, or (ii) in the interior rear-view mirror 112, (iii) or (near to) the CMS display device.

For option (i), the surveillance system arranged “in front of the driver”, as used herein, refers to a position generally aligned with the driver's frontal plane, i.e., more toward the driving direction than toward the lateral sides of the vehicle 10. Cameras arranged “in front of the driver” are located to face the driver directly from a central or forward-facing position relative to the driver, such as on the dashboard or steering column. This excludes in-cabin cameras mounted at the vehicle door or other lateral positions, even if those cameras have a line of sight to the driver's head 11. A more frontal placement improves the accuracy of detecting the driver's head movements, particularly when the driver is looking toward the opposite side exterior rear-view mirror, and supports the intended function of the camera monitoring system (CMS) for gesture-based control of the exterior field of view. Regarding option (ii), the surveillance system arranged in the interior rear-view mirror 112 may be positioned within the mirror housing itself or in the supporting leg or attachment of the assembly, provided it forms part of the interior rear-view mirror system and is oriented to capture the driver's head 11 for CMS functionality. Such frontal placement according to option (ii) enhances the accuracy and robustness of detecting the driver's head movements, particularly when the driver is looking at any exterior rear-view mirror, including the left-side, right-side, or interior rear-view mirror. This configuration provides a more stable and symmetrical view of the driver's head 11 and face across typical driving postures, thereby supporting reliable gesture-based control of the CMS. Additionally, positioning the surveillance system at or within the interior rear-view mirror 112 enables the same in-cabin camera to support further driver monitoring functions, including detection of driver somnolence, assessment of driver attention or alertness, and monitoring of vehicle occupants other than the driver. Accordingly, a single in-cabin camera may be configured to perform both CMS-related head-movement detection and broader occupant monitoring functions within the vehicle 10. For option (iii), the surveillance system may be integrated with the CMS display device, such that the display device is configured both to provide the displayed image of the exterior field of view and to capture the driver's head (11), enabling gesture-based control of the image region.

Preferably, the driver surveillance system may comprise a camera (i.e., the above-mentioned additional camera, which is an in-cabin driver monitoring camera). The surveillance system may be capable of working out the position and distance of the driver's head. In particular, the surveillance system is configured to process image data locally and to determine driver head position and/or distance information therefrom, rather than merely supplying raw image data. For example, by processing image data captured by the (additional) camera to derive head position and/or depth information, the surveillance system provides corresponding processed position and/or distance data to the ECU 500. In this way, the ECU 500 uses the processed position and/or distance data generated by the surveillance system to displace the image region 210, 211 within the captured image based on the position and distance of the driver's head 11.

Thus, the image region (210, 211) within the captured image may be manually controlled (e.g., by screen sliding command o by the touch-and-drag functionality), but also by the driver's head moving forward 12 when this movement is captured by the gesture detector. That is, the gesture detector, based on the driver's head movement, is configured to trigger displacement of the image region 210, 211 within the captured image 20 such that, in use, the displayed exterior field of view of the vehicle 20 is adjusted according to the driver's head movement.

In other words, the gesture detector is configured to identify, detect or determine driver's gestures (e.g., driver's head movements), wherein data related to the driver's gestures (e.g., driver's head movements) leads the image region 210, 211 to be moved within the captured image 20, the image region 210, 211 being displayed by the at least one display device 100, 101, 102 such that, in use, the displayed exterior field of view of the vehicle 10 is adjusted according to the driver's gestures.

In this embodiment, the exterior field of view (FOV) displayed to the user or driver may be continuously adjusted during driving based on at least one position of the driver's head 11. For example, the ECU 500 may be configured to continuously receive information from the in-cabin sensor (i.e., the surveillance system), and dynamically move the at least one image region 210, 211 within the captured image 20 in response thereto (see FIG. 18 where the image region 211 is arranged more central in the right drawing than the image region 211 of the left drawing corresponding to a previous captured image 20). In this manner, even small relative upward, downward, leftward, or rightward movements of the driver's head 11 may lead to a corresponding displacement of the image region 210, 211, thereby providing a continuous crop-and-pan functionality in which the displayed exterior FOV is progressively adjusted to the driver's current viewing requirements. This continuous adjustment allows the image region 210, 211 to be repositioned in real time within the captured image 20, ensuring that the driver is presented with an exterior FOV that remains aligned with the driver's natural head movements and intended viewing direction, or manual intervention.

The camera monitoring system (CMS) according to the present invention provides advantages in a wide range of vehicles 10, including passenger cars, vans, buses, and heavy-duty trucks. Although the benefits apply to all motor vehicle types, they are particularly pronounced in large commercial vehicles in which traditional exterior reflective mirrors are generally of considerable size in order to provide the required rear and sideward fields of view. Such large mirror housings of the prior art contribute noticeably to aerodynamic drag, increase energy consumption, generate wind-induced noise and vibration, and may present a risk of unintended contact with pedestrians or nearby infrastructure. By using compact mounting assemblies, such as winglets or other reduced-profile supports for the image capturing means, the external protrusion of the CMS can be substantially smaller than conventional rear-view mirror systems. This reduction in frontal and lateral area advantageously decreases aerodynamic resistance during driving and may therefore reduce both fuel consumption and electrical energy usage. The smaller exterior footprint also helps lower wind-related noise and vibrations and reduces the likelihood of accidental exterior impacts.

In addition, by incorporating the gesture detector and the surveillance system, the CMS allows the driver to adjust the displayed exterior field of view through natural movements of the head 11. The ECU 500 may adjust the position of the at least one image region 210, 211 as a result of a change in a relative head position angle (see reference sign X1 in FIG. 15). The head position angle is defined as the angle between the driver's head and a side portion of the vehicle 10 located forward of the driver in the vehicle's longitudinal driving direction. An increase in the head position angle corresponds to a movement of the driver's head forward 12 and/or toward the vehicle's longitudinal centerline, and the ECU 500 may responsively displace the image region 210, 211 laterally outward, i.e., in a direction away from the vehicle's longitudinal centerline. A decrease in the head position angle corresponds to a movement of the driver's head backward and/or toward the outer side of the vehicle 10, and the ECU 500 may responsively displace the image region 210, 211 laterally inward, i.e., in a direction toward the vehicle's longitudinal centerline.

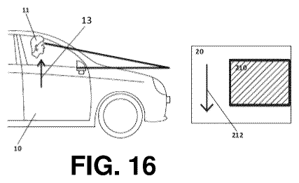

When the driver's head 11 moves relative to this reference direction, the ECU 500 may move the at least one image region 210, 211 within the captured image 20 in a manner that reflects the driver's natural intention to view more inwardly or outwardly (see FIG. 18). As shown in FIG. 15, a forward movement 12 of the driver's head and/or a movement toward the vehicle's longitudinal centerline corresponds to the driver's desire to see a field of view that extends further outward relative to the displayed image; accordingly, the ECU 500 may outwardly displace 21 the image region 210, 211 within the captured image 20. Conversely, a backward movement of the driver's head and/or a movement toward the outer side of the vehicle may correspond to the driver's desire to view a more inward portion of the exterior scene, and the ECU 500 may inwardly displace the image region 210, 211. As shown in FIG. 16, a similar relationship may apply vertically: downward driver head movement may result in the image region 210, 211 being displaced upward within the captured image (for example, to assist with parking maneuvers), while upward head movement 13 may cause a downward displacement 212. These relationships accommodate the inherent mirroring characteristics of a rear-view representation while ensuring that the displayed exterior field of view is continuously aligned with the driver's natural adjustments in posture, or manual intervention.

The at least one image region 210, 211 is smaller than the captured image 20 and, in a default operating state, is not centered within the captured image (see FIGS. 15 and 18). For the purposes of this disclosure, “default operating state” refers to typical driving conditions in which the image region is initially positioned at an inner lateral side of the captured image 20, thereby allowing the image region 210, 211 to be displaced as much as possible across the captured image 20 in response to driver head movements. For example, the image region 210, 211 is positioned at the right inner side of the captured image for vehicles 10. This initial lateral offset ensures that, during use, a maximum field of view adjustment can be achieved when the driver moves the head forward 12 and/or toward the vehicle's longitudinal centerline.

As explained above, the gesture detector may be configured to detect at least the driver's head 11. In particular, the gesture detector is configured to detect a first position of the detected part of the driver's head, and a second position of the driver's head. For example, the first position corresponds to a reference or initial position, and the second position to a current position. The ECU 500 is further configured to determine a movement of the detected part of the driver's head based on a comparison of the second position against the first position, at least along the driving direction of the vehicle or relative the above-mentioned head position angle.

FIG. 15 shows that, based on the determined driver's head movement, the ECU 500 is configured to adjust the position of the at least one image region 210, 211 within the captured image. In particular, the ECU 500 may displace the image region laterally along a horizontal axis of the captured image, outwardly 21 when the relative head position angle increases, and inwardly toward the vehicle's longitudinal centerline when the relative head position angle decreases. For example, the ECU 500 may move or displace the image region 210, 211 outward along the horizontal axis when the relative angle X2 (not shown) is greater than a relative angle X1.

The image capturing means is/are configured to operate at a frame rate of at least thirty frames per second (fps), for example sixty fps or more, to provide essentially instantaneous perception of the exterior environment, such that the driver perceives minimal or no temporal delay between real-world movements and the displayed image.

It is possible that the interior rear-view mirror system may be provided with a display mode (see FIG. 6). In such cases, a further (exterior) image capturing means may be included, comprising at least one camera associated with the interior rear-view mirror (i.e., to provide image to a display device 102 of the interior rear-view mirror system). This camera is particularly oriented rearward and optionally located within the vehicle's roof, for example within a sharkfin. In this way, said further exterior image capturing means may be configured to capture an image from an exterior field of view of the vehicle 10, wherein the field of view extends at least rearward outside the vehicle 10.

In a possible aspect, as shown in FIG. 6, an intelligent rear-view monitoring system (IRMS) is provided. The IRMS comprises:
a first camera monitoring system, including image capturing means 1112 located on the left side of the vehicle 10;
a second camera monitoring system, including image capturing means 1102 located on the right side of the vehicle 10;
an ECU 500 integrating the ECUs of the first and second camera monitoring systems; and
an image classifier for detecting or determining captured driver gestures. In examples, the image classifier comprises machine learning models such as deep learning.

In particular, the ECU 500 may be a single, centralized unit connected to both image capturing means 1102, 1112 and is configured to control the first and second camera monitoring systems. The ECU 500 further comprises the image classifier and may be arranged inside or in association with, or near, the interior (central) rear-view mirror along with the in-cabin camera.

FIG. 6 shows that the intelligent rear-view monitoring system further comprises an interior rear-view mirror system. A rear camera (e.g., 1400) is associated with the interior rear-view mirror system, wherein the interior rear-view mirror system is configured to provide the driver with an image captured by the rear camera, and wherein the ECU 500 also controls the interior rear-view mirror system. In this way, based on the driver's head movement, an image region is displaced within the captured image associated with the rear camera such that, in use, the displayed exterior field of view of the vehicle 10 corresponding to the interior rear-view mirror system is adjusted according to the driver's head movement.

In particular, the image region associated with the interior rear-view mirror system is arranged in a central position along a horizontal axis of the captured image in a default operating state, the default operating state. In this default operating state, the image region is arranged at least in a more central position along the horizontal axis than the image regions 210, 211 of the first and second camera monitoring systems. By contrast, the image regions 210, 211 of the lateral camera monitoring systems are arranged inwardly with respect to their respective captured images in the default operating state, meaning that they are displaced toward the interior of the vehicle 10 relative to the optical center of their respective captured images. From this default operating state, the image regions are dynamically displaced in response to detected driver head movements, in particular including forward head movements 12, to adjust the displayed exterior field of view.

Note that in this text, the term “comprises” and its derivations (such as “comprising”, etc.) should not be understood in an excluding sense, that is, these terms should not be interpreted as excluding the possibility that what is described and defined may include further elements, steps, etc.

While the present disclosure has been described with reference to an exemplary embodiment or embodiments, it will be understood by those skilled in the art that various changes may be made, and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

1. A camera monitoring system for motor vehicles, comprising:
image capturing means being associated with at least an exterior rear-view mirror of a vehicle, the exterior rear-view mirror being a mounting assembly located at an exterior part of the vehicle, the image capturing means being located at the mounting assembly and configured to capture an image from an exterior field of view of the vehicle, wherein the field of view extends at least sideward and rearward outside the vehicle and encompasses a portion of the exterior part of the vehicle;
an electronic control unit, ECU connected to the image capturing means;
a display device including at least a first screen located inside the vehicle and connected to the ECU;
a surveillance system arranged inside the vehicle, the surveillance system being configured to capture at least the driver's head; and
a gesture detector,
wherein the ECU is configured to select at least an image region from an image captured by the image capturing means, the image region being smaller than the captured image and movable within the captured image, wherein the image region is displayed by the display device, and
wherein the gesture detector, based on the driver's head movement, is configured to trigger displacement of the image region within the captured image such that, in use, the displayed exterior field of view of the vehicle is adjusted according to the driver's head movement.

2. The camera monitoring system according to claim 1, wherein the surveillance system comprises an additional camera inside the vehicle configured to capture the driver's head, such that driver's head movements are recognized in images of the driver captured by the additional camera.

3. The camera monitoring system according to claim 1, wherein the gesture detector is implemented in the ECU.

4. The camera monitoring system according to claim 1, wherein the gesture detector uses an image classifier.

5. The camera monitoring system according to claim 1, wherein the gesture detector performs a crop-and-pan functionality triggered by a driver's head movement.

6. The camera monitoring system according to claim 1, wherein the surveillance system is arranged within the vehicle, fixed
(i) in front of the driver,
(ii) in the interior rear-view mirror, or
(iii) in the CMS display device.

7. The camera monitoring system according to claim 1, wherein the driver's head movement is tracked by the surveillance system, wherein the surveillance system is capable of working out the position and/or distance of the driver's head.

8. The camera monitoring system according to claim 1, wherein the captured image is derived from a raw image acquired by the image capturing means that includes a symmetric image of the raw image with respect to a vertical axis of the captured image.

9. The camera monitoring system according to claim 8, wherein the symmetric image is generated by at least one of an image sensor of the image capturing means, an image signal processor (ISP), and by the ECU.

10. The camera monitoring system according to claim 1, wherein the captured image is generated as a symmetric image of a raw image by a System-on-Chip (SoC), the SoC comprising at least one of an image sensor of the image capturing means and an image signal processor (ISP), or being integrated within the ECU, and wherein the SoC performs real-time image processing to generate the captured image, wherein at least one image region is updated within the captured image in response to the driver's head movement, such that the displayed exterior field of view of the vehicle is adjusted according to the driver's head movement.

11. The camera monitoring system according to claim 1, wherein the ECU is configured to move the at least one image region within the capture image according to a relative angle (X1, X2) defined as the angle between the at least one obtained position of the part of the driver's body and the electronic display device,
wherein, for a first relative angle (X1) defined with respect to a first obtained position and a second relative angle (X2) is greater than first relative angle (X1), the ECU is configured to move the at least one image region at least to a left along a horizontal axis of the captured image if the vehicle is for right-hand traffic and at least to a right along the horizontal axis of the capture image if the vehicle is for left-hand traffic, and
wherein the exterior FOV is adjusted based on the at least one obtained position and the electronic display device is configured to display the adjusted exterior FOV in the at least one image region.

12. The camera monitoring system according to claim 1, wherein the ECU is further configured to:
a. move the image region corresponding to a downward vertical displacement such that the field of view, FOV, is vertically displaced in a downward direction, when the driving direction is changed from a forward driving direction to a reverse driving direction, and
b. move the image region corresponding to an upward vertical displacement such that the field of view, FOV, is vertically displaced in an upward direction, when the driving direction is changed from a reverse driving direction to a forward driving direction.

13. The camera monitoring system according to claim 1, wherein the ECU is configured to determine a relative upward and downward movement of the exterior rear-view mirror from a change in the pitch angle value, and further configured to:
(a) move the image region corresponding to a downward vertical displacement such that the field of view, FOV, is vertically displaced in a downward direction, when the exterior rear-view mirror is downwardly moved, and
(b) move the image region corresponding to an upward vertical displacement such that the field of view, FOV, is vertically displaced in an upward direction, when the exterior rear-view mirror is upwardly moved.

14. The camera monitoring system according to claim 1, wherein the ECU is configured to move the image region such that the zoom of the displayed image increases when the driving speed is increased and such that it surpasses the predefined driving speed value, while the image region area is decreased when the vehicle speed falls below a predefined driving speed value.

15. A motor vehicle comprising an intelligent rear-view monitoring system, the intelligent rear-view monitoring system includes:
a first camera monitoring system according to claim 1 with image capturing means located on the left side of the vehicle and associated with an exterior rear-view mirror of the left side,
a second camera monitoring system according to claim 1 with image capturing means located on the right side of the vehicle and associated with an exterior rear-view mirror of the right side, and
wherein a single ECU, connected to the image capturing means of the first and second camera monitoring systems, is configured to control the first camera monitoring system and the second camera monitoring system.

16. The motor vehicle comprising the intelligent rear-view monitoring system according to claim 15, wherein it further comprises an interior rear-view mirror system, and a rear camera, wherein the interior rear-view mirror system is configured to provide the driver with an image of the rear camera, and wherein the ECU also controls the interior rear-view mirror system.

17. The motor vehicle comprising the intelligent rear-view monitoring system according to claim 16, wherein, in a default operating state, an image region associated with the interior rear-view mirror system is arranged at least in a more central position along a horizontal axis of the captured image of the rear camera than the image regions of the first and second camera monitoring systems are arranged along a horizontal axis of their respective captured images.
